(19) United States
(12) Patent Application Publication
(10) Pub. No.: US 2021/0072597 A1
(43) Pub. Date: Mar. 11, 2021

(54) DISPLAY DEVICE AND TILED DISPLAY DEVICE HAVING THE SAME

(71) Applicant: Samsung Display Co., LTD., Yongin-si (KR)

(72) Inventors: JAE SUL AN, Hwaseong-si (KR); Juyoun Son, Cheonan-si (KR); Dohun Kim, Suwon-si (KR)

(21) Appl. No.: 16/903,321

(22) Filed: Jun. 16, 2020

(30) Foreign Application Priority Data
Sep. 6, 2019 (KR) 10-2019-0110526

(51) Int. Cl. G02F 1/13357; G02F 1/1335; G02F 1/1333

(52) U.S. Cl. CPC G02F 1/133606; G02F 1/133514; G02F 2202/28; G02F 1/13336; G02F 1/133504

(57) ABSTRACT

A display device includes: a first member including a light emitting unit to emit light; a second member disposed on the first member; and a display panel disposed on the second member. The second member includes: a base substrate; a fiber diffusion layer disposed on the base substrate and including a nonwoven fabric; and a filter layer disposed under the base substrate and facing the first member, the filter layer having a reflectance and a transmittance, which vary depending on an incident angle of light of a specific wavelength. The base substrate has a thermal expansion coefficient lower than thermal expansion coefficients of the fiber diffusion layer and the filter layer.

### CROSS-REFERENCE TO RELATED APPLICATION

This application claims priority from and the benefit of Korean Patent Application No. 10-2019-0110526, filed on Sep. 6, 2019, which is hereby incorporated by reference for all purposes as if fully set forth herein.

### BACKGROUND

### Field

Exemplary implementations of the invention relate generally to a display device, and more specifically, to a display device including a light source member.

### Discussion of the Background

Various display devices are being used to provide image information, and a liquid crystal display device is widely applied to various types of display devices such as a tiled display device and a mobile display device since it has an advantage such as low power consumption.

The liquid crystal display device generates an image using light provided from a backlight unit, and the backlight unit includes a plurality of light emitting units that emits the light. A variety of optical members is provided under a display panel to increase a light efficiency of the light provided from the light emitting units and a color reproducibility of the liquid crystal display device.

The above information disclosed in this Background section is only for understanding of the background of the inventive concepts, and, therefore, it may contain information that does not constitute prior art.

### SUMMARY

Display devices constructed according to the principles and exemplary implementations of the invention are capable of decreasing an optical distance between a light source member and an optical member. The display device may have improved appearance as the optical distance decreases. For example, the optical member may include a filter layer facing the light source member to prevent or at least reduce hot spot phenomenon effectively, which may enable the optical distance between the light source member and the optical member to be reduced, as well as the overall thickness of the display device.

Display devices constructed according to the principles and exemplary implementations of the invention are capable of being provided as a tiled display device, such as a public information display (PID), having a reduced size of a boundary area between adjacent display devices. For example, the display device may have an optical member including a base substrate having a low thermal expansion coefficient and optical functional layers attached to the base substrate. Accordingly, expansion caused by heat generated by the optical functional layers such as a filter layer and a fiber diffusion layer may be effectively suppressed by the base substrate, and thus the boundary area between the tiled display devices is reduced.

Additional features of the inventive concepts will be set forth in the description which follows, and in part will be apparent from the description, or may be learned by practice of the inventive concepts.

According to one aspect of the invention, a display device includes: a first member including a light emitting unit to emit light; a second member disposed on the first member; and a display panel disposed on the second member. The second member includes: a base substrate; a fiber diffusion layer disposed on the base substrate and including a nonwoven fabric; and a filter layer disposed under the base substrate and facing the first member, the filter layer having a reflectance and a transmittance, which vary depending on an incident angle of light of a specific wavelength, wherein the base substrate has a thermal expansion coefficient lower than thermal expansion coefficients of the fiber diffusion layer and the filter layer.

The display panel may include a color conversion layer including quantum dots to convert the light from a first color to a second color and a third color.

The filter layer may include a plurality of first refractive layers and a plurality of second refractive layers alternately disposed with the first refractive layers, and the first refractive layers may have a refractive index different from a refractive index of the second refractive layers.

The filter layer may be configured to selectively reflect light of a specific wavelength band.

The specific wavelength band of light may be about 450 nm.

The transmittance may have a maximum value in response to the incident angle being in a range from about 40 degrees to about 80 degrees.

The filter layer may be disposed directly under the base substrate.

The fiber diffusion layer may be disposed above the base substrate and faces the display panel.

The fiber diffusion layer may be disposed between the base substrate and the filter layer.

The second member may include an optical member including the base substrate, the fiber diffusion layer, and the filter layer, and the optical member may further include a light diffusion layer that is disposed on the fiber diffusion layer to convert light corresponding to a linear light source or a point light source to light corresponding to a surface light source.

The second member may further include an adhesive layer disposed at least one of between the base substrate and the filter layer and between the base substrate and the fiber diffusion layer.

The adhesive layer may include a plurality of patterns spaced apart from each other.

The adhesive layer may include a plurality of openings.

The second member may further include a dual brightness enhancement film (DBEF) disposed on the base substrate.

The first member may include a light source member including the light emitting unit, the light emitting unit including: a circuit board; and a plurality of light emitting elements disposed on the circuit board and independently activated.

The second member may further include a condensing layer disposed on the fiber diffusion layer, and the fiber diffusion layer may be disposed between the condensing layer and the base substrate.

The second member may further include: a condensing layer disposed on the base substrate; and a dual brightness enhancement film (DBEF) disposed on the condensing layer.

According to another aspect of the invention, a display device includes: a first member including a light emitting unit to emit light; a second member disposed on the first member; and a display panel disposed on the second member, the second member including: a base substrate; a fiber diffusion layer disposed on the base substrate and including a nonwoven fabric; a filter layer disposed under the base substrate and facing the first member, the filter layer having a reflectance and a transmittance, which vary depending on an incident angle of light of a specific wavelength; and a color conversion layer disposed on the base substrate and including quantum dots to convert the light from a first color to a second color and a third color, wherein the base substrate has a thermal expansion coefficient lower than thermal expansion coefficients of the fiber diffusion layer and the filter layer.

The second member may include an optical member including the base substrate, the fiber diffusion layer, and the filter layer, and the optical member may further include a barrier layer disposed on at least one of an upper surface and a lower surface of the color conversion layer.

According to yet another aspect of the invention, a tiled display device includes: a first display area and a second display area, which are adjacent to each other in a plan view and respectively include display devices; and a bezel area disposed between the first display area and the second display area, each of the display devices including: a first member including a light emitting unit to emit light; a second member disposed on the first member; and a display panel disposed on the second member. The second member includes: a base substrate; a fiber diffusion layer disposed on the base substrate and including a nonwoven fabric; and a filter layer disposed under the base substrate and facing the first member, the filter layer having a reflectance and a transmittance, which vary depending on an incident angle of light of a specific wavelength, wherein the base substrate has a thermal expansion coefficient lower than thermal expansion coefficients of the fiber diffusion layer and the filter layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is an exploded perspective view of a display device constructed according to the principles of the invention.

FIG. 2 is an equivalent circuit diagram of an exemplary embodiment of a light emitting unit of FIG. 1.

FIG. 3 is a cross-sectional view taken along line I-I′ of FIG. 1 according to an exemplary embodiment.

FIG. 4 is a cross-sectional view of an exemplary embodiment of the color conversion layer of FIG. 3.

FIG. 5A is a cross-sectional view of an exemplary embodiment of the optical member of FIG. 1.

FIG. 5B is a cross-sectional view of another exemplary embodiment of the optical member of FIG. 1.

FIG. 5C is a cross-sectional view of still another exemplary embodiment of the optical member of FIG. 1.

FIG. 5D is a cross-sectional view of still yet another exemplary embodiment of the optical member of FIG. 1.

FIG. 6 is a cross-sectional view taken along line I-I′ of FIG. 1 according to another exemplary embodiment.

FIG. 7 is a cross-sectional view of an exemplary embodiment of the color conversion layer of FIG. 6.

FIG. 8A is a cross-sectional view of an exemplary embodiment of a filter layer.

FIG. 8B is a diagram for illustrating optical characteristics of a filter layer.

FIG. 8C is a graph illustrating transmittance of a filter layer for light having a specific wavelength according to the incident angle of the light.

FIG. 9 is a cross-sectional view of an exemplary embodiment of a fiber diffusion layer.

FIG. 10A is a plan view of an exemplary embodiment of an adhesive layer.

FIG. 10B is a cross-sectional view taken along line II-II′ of FIG. 10A.

FIG. 11A is a plan view of a tiled display device constructed according to the principles of the invention.

FIG. 11B is a cross-sectional view taken along line III-III′ of FIG. 11A according to an exemplary embodiment.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z—axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

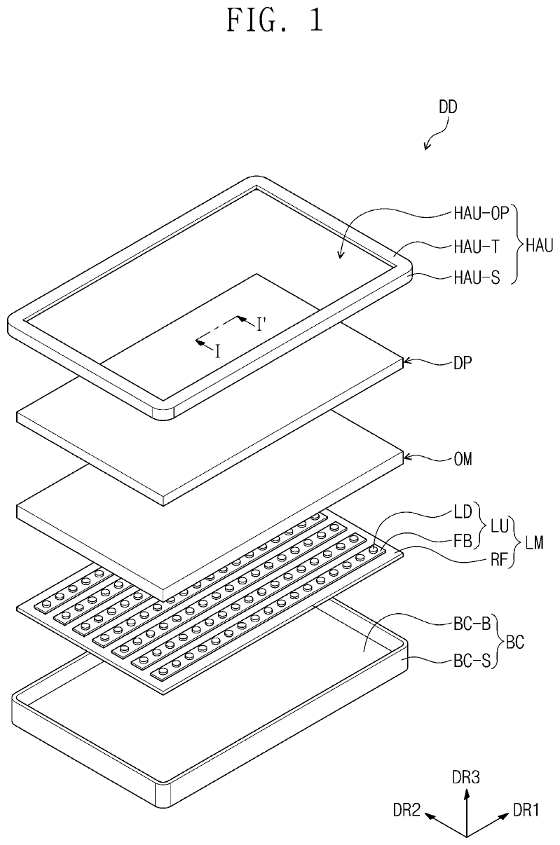

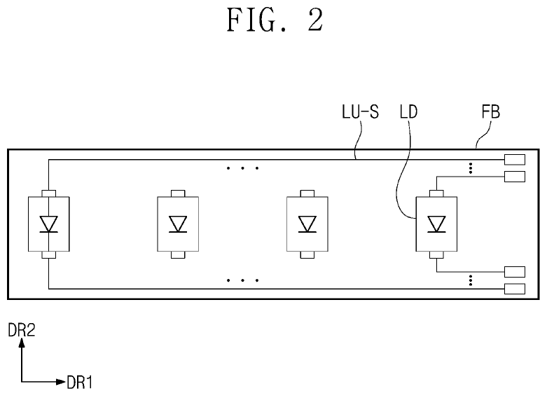

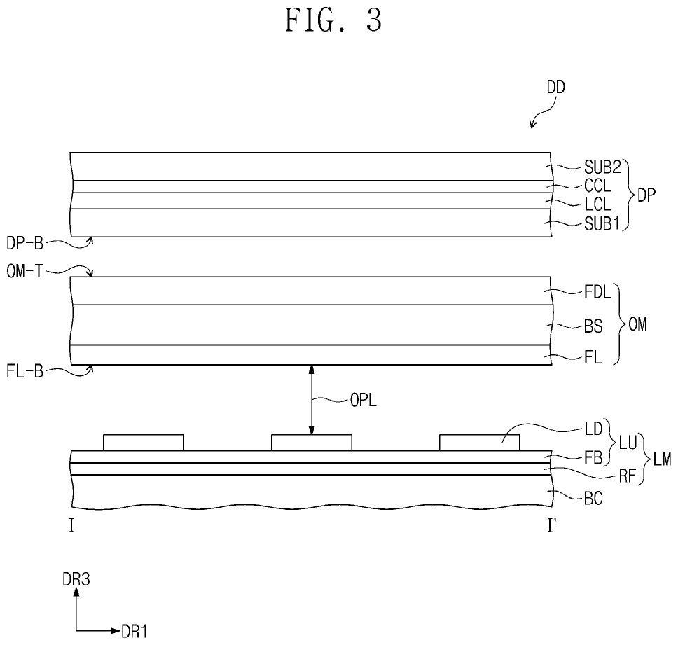

FIG. 1 is an exploded perspective view of a display device constructed according to the principles of the invention. FIG. 2 is an equivalent circuit diagram of an exemplary embodiment of a light emitting unit of FIG. 1. FIG. 3 is a cross-sectional view taken along line I-I′ of FIG. 1 according to an exemplary embodiment.

Referring to FIGS. 1 to 3, the display device DD may include a display panel DP and a light source member LM having a plurality of light emitting units LU and an optical member OM. The optical member OM may be disposed between the light source member LM and the display panel DP. That is, the display device DD may include the light source member LM, the optical member OM, and the display panel DP, which are sequentially stacked in a third directional axis DR3.

FIG. 1 shows first, second, and third directional axes DR1, DR2, and DR3, the directional axes described in the present disclosure are relative to each other, and for the convenience of explanation, the third directional axis DR3 in FIG. 1 may be defined as a direction in which an image is provided to a user. In addition, the first directional axis DR1 and the second directional axis DR2 may be substantially perpendicular to each other, and the third directional axis DR3 may be a normal line direction with respect to a plane defined by the first directional axis DR1 and the second directional axis DR2.

Front (upper) and rear (lower) surfaces of each member of the display device DD described hereinafter may be distinguished from each other by the third directional axis DR3. However, the first, second, and third directional axes DR1, DR2, and DR3 are merely exemplary. Hereinafter, first, second, and third directions are defined as directions respectively indicated by the first, second, and third directional axes DR1, DR2, and DR3 and assigned with the same reference numerals.

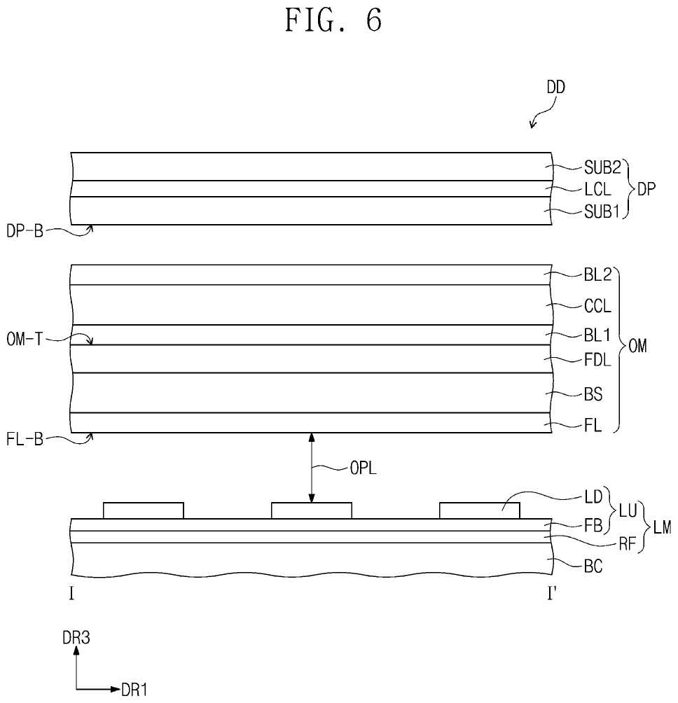

The display panel DP of the display device DD may overlap the light source member LM. The display panel DP may be disposed above the light source member LM, and the display device DD may include a direct-type light source member LM. In addition, the optical member OM may be disposed between the light source member LM and the display panel DP to overlap the light source member LM and the display panel DP. In an exemplary embodiment, the optical member OM may convert light emitted from the light source member LM and may transmit the converted light to the display panel DP. In this manner, the optical member OM may include a color conversion layer CCL as shown in FIG. 6.

The display device DD may include a bottom cover BC. The bottom cover BC disposed under the light source member LM may accommodate the light source member LM, the optical member OM, and the display panel DP. The bottom cover BC may include a bottom portion BC-B and sidewall portions BC-S bent and extending from the bottom portion BC-B.

The bottom cover BC may be formed from metal and/or plastic.

A housing HAU may be disposed above the display panel DP. In the display device DD, the bottom cover BC may be coupled to the housing HAU to accommodate the display panel DP, the optical member OM, and the light source member LM. The housing HAU may be formed from metal and/or plastic.

The housing HAU may be disposed above the display panel DP to cover an edge of the display panel DP. The housing HAU may be provided with an opening HAU-OP through which the image is provided. According to an exemplary embodiment, the housing HAU may have a substantially rectangular frame shape in a plan view. The housing HAU may include a housing sidewall portion HAU-S and a front surface portion HAU-T bent from the housing sidewall portion HAU-S. According to an exemplary embodiment, the front surface portion HAU-T may be omitted.

A mold member may be further disposed between the bottom cover BC and the housing HAU. The mold member may support the display panel DP such that the display panel DP is spaced apart from the light source member LM by a predetermined distance.

The light source member LM may be disposed under the display panel DP. The light source member LM may be provided on the bottom portion BC-B of the bottom cover BC. The light source member LM may include a plurality of light emitting units LU and a reflective plate RF. The light emitting units LU may be disposed on the reflective plate RF. The light emitting units LU may be disposed under the display panel DP and the optical member OM.

Each of the light emitting units LU may include a plurality of light emitting elements LD as a point light source and a circuit board FB that provides electrical signals to the light emitting elements LD. Each of the light emitting elements LD may include a light emitting diode. The light emitting units LU may include different numbers of light emitting elements LD.

The light emitting elements LD are arranged at regular intervals in FIG. 1, however, exemplary embodiments are not limited thereto or thereby. For example, the intervals between the light emitting elements LD may be changed depending on positions in the display panel DP, e.g., a center area or an edge area. The intervals between the light emitting elements LD may be different in each different light emitting unit LU.

The light emitting element LD may receive the electrical signals from the circuit board FB to emit the light. The display device DD may further include a connection circuit board that electrically connects the light emitting units LU to each other. A dimming circuit may be disposed in the connection circuit board. The dimming circuit may dim the light emitting units LU based on a control signal provided from a central control circuit. According to an exemplary embodiment, the light emitting elements LD may be independently turned on or off. For example, the light emitting elements LD included in one light emitting unit LU may be turned on or off independently of each other. For example, one light emitting unit LU may include a turned-on light emitting element and a turned-off light emitting element disposed adjacent to the turned-on light emitting element.

In addition, the light emitting elements LD included in the one light emitting unit LU may be dimmed independently of each other. The light emitting elements LD may be respectively connected to signal lines LU-S to be dimmed. The circuit boards FB may have a shape extending in the first directional axis DR1.

Referring to FIG. 1 again, the light source member LM may further include the reflective plate RF. The reflective plate RF may be disposed on the bottom portion BC-B of the bottom cover BC and may cover substantially the entire planar surface area of the bottom portion BC-B, however, exemplary embodiments are not limited thereto or thereby. The reflective plate RF may not overlap the light emitting unit LU. For example, the reflective plate RF may be disposed on the bottom portion BC-B of the bottom cover BC without overlapping the light emitting units LU.

The reflective plate RF may be a reflective film or may include a reflective coating layer. The reflective plate RF may reflect the light transmitted downwardly such that the reflected light enters the optical member OM.

Referring to FIG. 3, the display panel DP of the display device DD may include a first substrate SUB1, a second substrate SUB2 facing the first substrate SUB1, and a liquid crystal layer LCL disposed between the first substrate SUB1 and the second substrate SUB2. The display panel DP may include a display area and a peripheral area surrounding the display area. The display area may be an area through which the image is displayed in a plan view, and the peripheral area may be defined adjacent to the display area in the plan view. The image is not displayed in the peripheral area. The display panel DP may include a plurality of pixels arranged in the display area. According to an exemplary embodiment, the display panel DP may include the color conversion layer CCL. For example, the color conversion layer CCL of the display panel DP may be disposed on the liquid crystal layer LCL.

One substrate (hereinafter, referred to as an “array substrate”) of the first substrate SUB1 and the second substrate SUB2 may include signal lines and a pixel circuit of the pixels, which are formed therein. The array substrate may be connected to a main circuit board by a chip-on-film (COF). The central control circuit may be disposed on the main circuit board to drive the display panel DP. The central control circuit may be a microprocessor. A chip of the COF may include a data driving circuit. A gate driving circuit may be mounted on the array substrate or may be directly integrated in the array substrate by a low temperature poly-silicon (LTPS) process. The central control circuit may control the light emitting units LU. The central control circuit may transmit the control signal to the dimming circuit of the light emitting units LU to control the light emitting units LU.

Referring to FIG. 3, the optical member OM of the display device DD may include a filter layer FL, a fiber diffusion layer FDL, and a base substrate BS. The filter layer FL may be disposed at the lowest position in the optical member OM. The fiber diffusion layer FDL may be disposed on the filter layer FL. The base substrate BS may be disposed on the fiber diffusion layer FDL. For example, the base substrate BS may be disposed between the fiber diffusion layer FDL and the filter layer FL.

The optical member OM may transmit the light provided from the light emitting unit LU of the light source member LM or may convert the light provided from the light emitting unit LU of the light source member LM to provide the converted light to the display panel DP. In addition, the optical member OM may include a plurality of optical functional layers to effectively transmit the light provided from the light emitting unit LU to the display panel DP.

The base substrate BS of the optical member OM may include a glass material, however, exemplary embodiments are not limited thereto or thereby. The base substrate BS may include a material having a thermal expansion coefficient lower than thermal expansion coefficients of the filter layer FL and the fiber diffusion layer FDL. The base substrate BS may serve as a base on which optical functional layers, such as the filter layer FL and the fiber diffusion layer FDL are disposed.

The optical member OM may be disposed on the light source member LM, and a lower surface FL-B of the filter layer FL, which corresponds to a lower surface of the optical member OM, may be spaced apart from the light emitting unit LU by an optical distance OPL. The light provided from the light emitting unit LU may be incident into the lower surface FL-B of the filter layer FL. As the optical member OM includes the filter layer FL disposed on the lower surface thereof, the optical distance OPL between the light emitting unit LU and the filter layer FL may effectively decrease. Since the filter layer FL does not need to be aligned with the light emitting unit LU, the optical distance OPL may decrease compared with an existing pattern format. Hereinafter, the filter layer FL is described.

The filter layer FL may be disposed under the base substrate BS and face the light source member LM. For example, the filter layer FL may be directly disposed on the base substrate BS. The filter layer FL may be coated or disposed on the lower surface of the base substrate BS. In addition, the filter layer FL may be disposed under the fiber diffusion layer FDL disposed on the lower surface of the base substrate BS.

The filter layer FL may have a variable reflectance or transmittance depending on the angle of incidence of the light (“incident angle”). The filter layer FL may selectively reflect or transmit light having a specific wavelength band. According to an exemplary embodiment, the filter layer FL may selectively reflect light having a specific wavelength band including a wavelength of about 450 nm. For example, the filter layer FL may selectively reflect a first color light having the specific wavelength band including the wavelength of about 450 nm. According to an exemplary embodiment, the filter layer FL may have the transmittance varied depending on the incident angle of the light at the specific wavelength. For example, the filter layer FL may reflect the first color light of about 450 nm which is vertically incident thereto, and may transmit a portion of the first color light of about 450 nm which is incident at an angle inclined with respect to the vertical incident light. That is, the filter layer FL may be a selective transmission-reflection layer. The filter layer FL may reflect vertically incident blue light to alleviate hot-spot phenomena.

As such, the filter layer FL reflects a portion of the light which is vertically incident thereto and transmits other portion of the light which is incident thereto at the angle inclined with respect to the vertical incident light. Since the vertically incident light does not reach or only partially reaches the display panel DP, the hot-spot occurring on the display panel due to a relatively large amount of light concentrated in and/or reaching portions of the display panel DP overlapping the light emitting elements LD may be alleviated, and the display quality of the display device DD may be improved. Since the filter layer FL is disposed at the lowest position in the optical member OM and the filter layer FL alleviates the hot-spot, the display device DD may be provided and/or designed such that the optical distance OPL between the optical member OM and the light source member LM decreases. A decrease in the optical distance OPL generally improves the appearance of the display device DD.

Also, since the fiber diffusion layer FDL and the filter layer FL are attached to the base substrate BS and the base substrate BS has a thermal expansion coefficient lower than those of the fiber diffusion layer FDL and the filter layer FL, the base substrate BS may suppress expansion of the fiber diffusion layer FDL and the filter layer FL caused by heat generated from the fiber diffusion layer FDL and the filter layer FL. Also, the base substrate BS disposed between the fiber diffusion layer FDL and the filter layer FL may dissipate the heat generated from the fiber diffusion layer FDL and the filter layer FL. Accordingly, the display device DD may be provided and/or designed such that distances between the optical member OM and other neighboring components decreases. Thus, the display device DD may have a reduced size.

The filter layer FL may have a single-layered structure or a multi-layered structure of a plurality of refractive layers stacked one on another. For example, the filter layer FL may include the refractive layers, and a wavelength band of the filter layer FL for transmission and reflection may be determined depending on the difference in refractive index between the stacked refractive layers, the thickness of each of the stacked refractive layers, and the number of the stacked refractive layers.

According to an exemplary embodiment, the optical member OM may include the fiber diffusion layer FDL. The fiber diffusion layer FDL may have a relatively thin thickness and may effectively diffuse the light incident thereto. The fiber diffusion layer FDL may be disposed on the filter layer FL. According to an exemplary embodiment, the fiber diffusion layer FDL may be disposed on the base substrate BS.

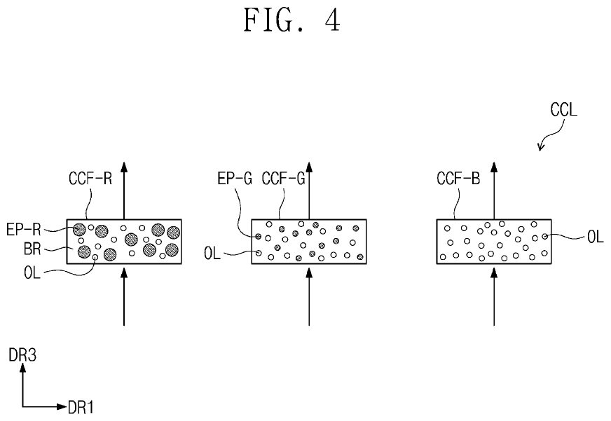

FIG. 4 is a cross-sectional view of an exemplary embodiment of the color conversion layer of FIG. 3.

Referring to FIG. 4, the color conversion layer CCL may receive the first color light. The color conversion layer CCL may convert the first color light to another color light or may transmit the first color light as it is.

The color conversion layer CCL may include a first conversion portion CCF-R, a second conversion portion CCF-G, and a transmission portion CCF-B. The first conversion portion CCF-R may convert the first color light to a second color light having a different color from the first color light and may emit the second color light. The second conversion portion CCF-G may convert the first color light to a third color light having a different color from the second color light and may emit the third color light. The transmission portion CCF-B may transmit the first color light.

In an exemplary embodiment, the first conversion portion CCF-R may include a first light emitting body EP-R to absorb the first color light that is the blue light and to emit the second color light that is the red light, and the second conversion portion CCF-G may include a second light emitting body EP-G to absorb the first color light and to emit the third color light that is the green light. The transmission portion CCF-B does not include the light emitting body. The transmission portion CCF-B may transmit the first color light.

In addition, the first conversion portion CCF-R, the second conversion portion CCF-G, and the transmission portion CCF-B may include a base resin BR. The base resin BR may be a polymer resin. For instance, the base resin BR may be an acrylic-based resin, a urethane-based resin, a silicone-based resin, or an epoxy-based resin. The base resin BR may be a transparent resin.

Further, each of the first conversion portion CCF-R, the second conversion portion CCF-G, and the transmission portion CCF-B may further include scattering particles OL. The scattering particles OL may be TiO2 or silica-based nanoparticles. The scattering particles OL may scatter the light emitting from the light emitting body to emit the scattered light to the outside of the conversion portion. In addition, in the case where the provided light transmits through the transmission portion CCF-B as it is, the scattering particles OL may scatter the provided light and may emit the scattered light to the outside.

The first and second light emitting bodies (hereinafter, referred to as “light emitting bodies”) EP-R and EP-G included in the color conversion layer CCL may be fluorescent substances or quantum dots. That is, the color conversion layer CCL may include at least one of the fluorescent substances or the quantum dots as the light emitting bodies EP-R and EP-G.

As an example, the fluorescent substances used as the light emitting bodies EP-R and EP-G may be an inorganic fluorescent substance. According to an exemplary embodiment, the fluorescent substances used in the display panel DP as the light emitting bodies EP-R and EP-G may be a green fluorescent substance or a red fluorescent substance.

The type of fluorescent substances used in the color conversion layer CCL is not limited to the above-disclosed material, and any known fluorescent substance other than the above-described fluorescent substance may be used.

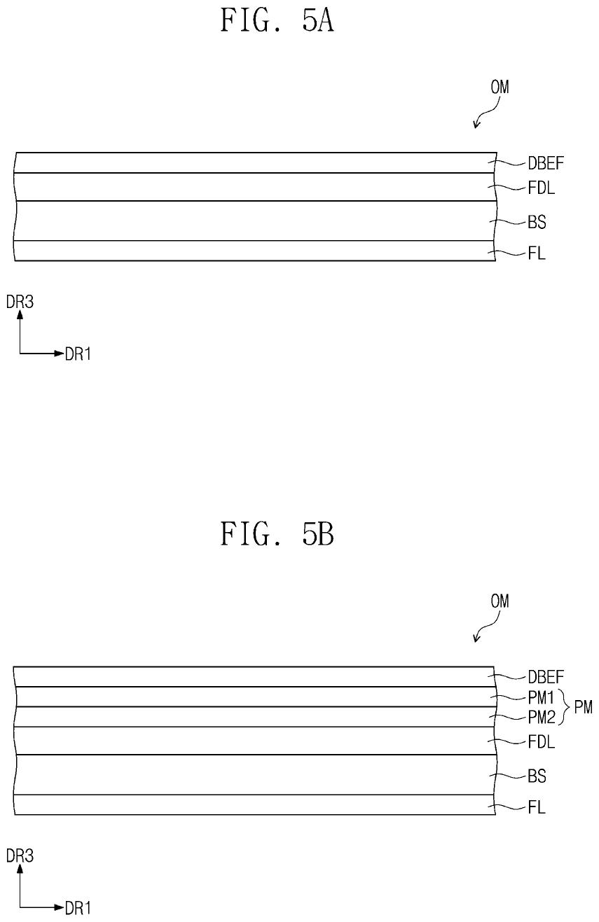

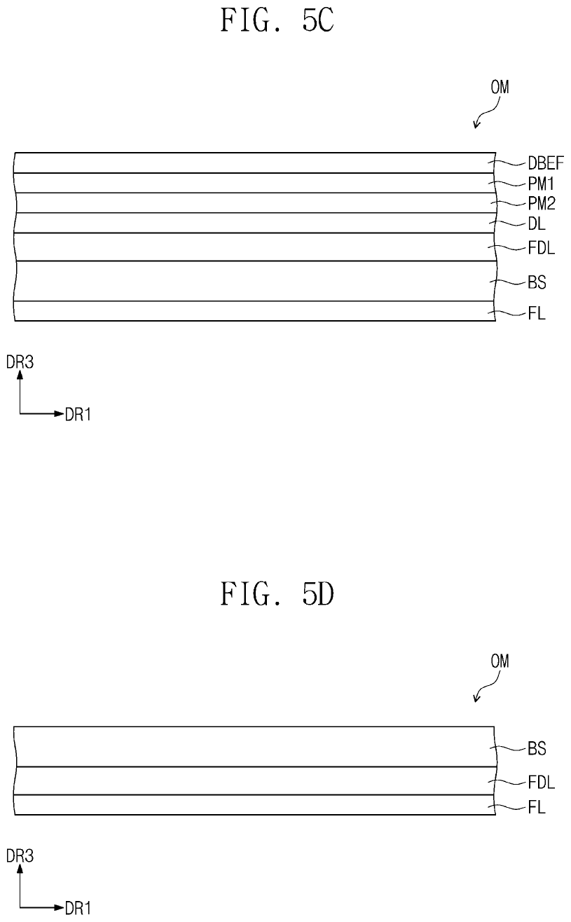

FIG. 5A is a cross-sectional view of an exemplary embodiment of the optical member of FIG. 1.

Referring to FIG. 5A, the optical member OM may include a filter layer FL, a base substrate BS disposed on the filter layer FL, a fiber diffusion layer FDL disposed on the base substrate BS, and a dual brightness enhancement film (DBEF) disposed on the fiber diffusion layer FDL. In this case, the DBEF may selectively transmit the light depending on a wavelength of the light and may reflect the light having different wavelength to the reflective plate RF. The DBEF includes films having different refractive indices and alternately stacked one on another, and thus, only a P wave may transmit through the DBEF. The DBEF may reflect an S wave and may transmit the S wave when the S wave is converted to the P wave, and thus, display brightness may be improved.

FIG. 5B is a cross-sectional view of another exemplary embodiment of the optical member of FIG. 1.

Referring to FIG. 5B, the optical member OM may further include a condensing layer PM in addition to the components of the optical member OM shown in FIG. 5A. The condensing layer PM may be disposed between a fiber diffusion layer FDL and a DBEF. The condensing layer PM may include a first condensing sheet PM1 and a second condensing sheet PM2. The first condensing sheet PM1 may correspond to a horizontal prism sheet, and the second condensing sheet PM2 may correspond to a vertical prism sheet. The first condensing sheet PM1 may be disposed above the second condensing sheet PM2, but exemplary embodiments are not limited thereto or thereby. For example, the second condensing sheet PM2 may be disposed above the first condensing sheet PM1. The condensing layer PM may refract the light exiting from the light source member LM and may condense the light such that the light is vertically incident to the display panel DP.

FIG. 5C is a cross-sectional view of still another exemplary embodiment of the optical member of FIG. 1.

Referring FIG. 5C, the optical member OM may further include a light diffusion layer DL in addition to the components of the optical member OM shown in FIG. 5B. The light diffusion layer DL may be disposed between a fiber diffusion layer FDL and a condensing layer PM. The light diffusion layer DL may be disposed on the fiber diffusion layer FDL and may convert light corresponding to a point light source or a linear light source exiting from the light source member LM to light corresponding to a surface light source. That is, the light diffusion layer DL may diffuse the light exiting from the light source member LM together with the fiber diffusion layer FDL to allow the light to be uniform.

FIG. 5D is a cross-sectional view of still yet another exemplary embodiment of the optical member of FIG. 1.

Referring to FIG. 5D, the fiber diffusion layer FDL may be disposed between the base substrate BS and the filter layer FL.

FIG. 6 is a cross-sectional view taken along line I-I′ of FIG. 1 according to another exemplary embodiment.

Referring to FIG. 6, a display device DD may further include a color conversion layer CCL in an optical member OM. The color conversion layer CCL may be disposed above a base substrate BS or a fiber diffusion layer FDL.

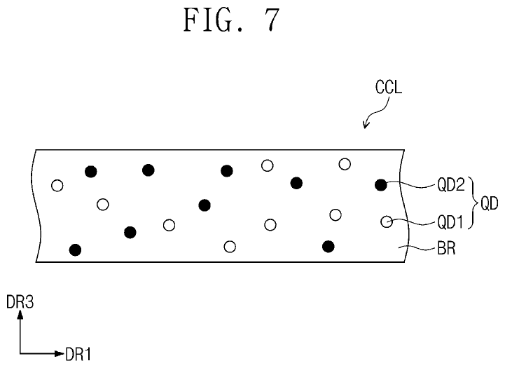

FIG. 7 is a cross-sectional view of an exemplary embodiment of the color conversion layer of FIG. 6.

Referring to FIG. 7, the color conversion layer CCL may include a base resin BR and quantum dots QD. The quantum dots QD may be distributed in the base resin BR.

The base resin BR may be a medium in which the quantum dots QD are distributed and may include a variety of resin compositions, which may generally be referred to as binders, however, exemplary embodiments are not limited thereto or thereby. In this disclosure, the medium may be referred to as the base resin BR regardless of its name, additional functions, or materials as long as it is a medium in which the quantum dots QD may be dispersed and distributed. The base resin BR may be a polymer resin. For example, the base resin BR may be an acrylic-based resin, a urethane-based resin, a silicone-based resin, or an epoxy-based resin. The base resin BR may be a transparent resin.

The quantum dots QD may be particles that convert the wavelength of light provided from the light emitting unit LU shown in FIG. 6. The quantum dots QD are a material with crystal structure of several nanometers, are composed of hundreds to thousands of atoms, and show a quantum confinement effect in which an energy band gap increases due to its small size. When light of a wavelength having a higher energy than the band gap is incident to the quantum dots QD, the quantum dots QD are excited by absorbing the light and fall to a ground state while emitting light of a specific wavelength. The wavelength of the emitted light has a value corresponding to the band gap. Light emission characteristics of the quantum dots QD due to the quantum confinement effect may be controlled by adjusting the size and composition of the quantum dots QD. The quantum dots QD may be selected from a group II-VI compound, a group III-V compound, a group IV-VI compound, a group IV element, a group IV compound, and a combination thereof.

The group II-VI compound may be selected from a binary compound selected from the group consisting of CdSe, CdTe, ZnS, ZnSe, ZnTe, ZnO, HgS, HgSe, HgTe, MgSe, MgS, and a mixture thereof, a ternary compound selected from the group consisting of CdSeS, CdSeTe, CdSTe, ZnSeS, ZnSeTe, ZnSTe, HgSeS, HgSeTe, HgSTe, CdZnS, CdZnSe, CdZnTe, CdHgS, CdHgSe, CdHgTe, HgZnS, HgZnSe, HgZnTe, MgZnSe, MgZnS, and a mixture thereof, and a quaternary compound selected from the group consisting of HgZnTeS, CdZnSeS, CdZnSeTe, CdZnSTe, CdHgSeS, CdHgSeTe, CdHgSTe, HgZnSeS, HgZnSeTe, HgZnSTe, and a mixture thereof.

The group III-V compound may be selected from a binary compound selected from the group consisting of GaN, GaP, GaAs, GaSb, AlN, AlP, AlAs, AlSb, InN, InP, InAs, InSb, and a mixture thereof, a ternary compound selected from the group consisting of GaNP, GaNAs, GaNSb, GaPAs, GaPSb, AlNP, AlNAs, AlNSb, AlPAs, AlPSb, InNP, InNAs, InNSb, InPAs, InPSb, GaAlNP, and a mixture thereof, and a quaternary compound selected from the group consisting of GaAlNAs, GaAlNSb, GaAlPAs, GaAlPSb, GaInNP, GaInNAs, GaInNSb, GaInPAs, GaInPSb, InAlNP, InAlNAs, InAlNSb, InAlPAs, InAlPSb, and a mixture thereof.

The group IV-VI compound may be selected from a binary compound selected from the group consisting of SnS, SnSe, SnTe, PbS, PbSe, PbTe, and a mixture thereof, a ternary compound selected from the group consisting of SnSeS, SnSeTe, SnSTe, PbSeS, PbSeTe, PbSTe, SnPbS, SnPbSe, SnPbTe, and a mixture thereof, and a quaternary compound selected from the group consisting of SnPbSSe, SnPbSeTe, SnPbSTe, and a mixture thereof. The group IV element may be selected from the group consisting of Si, Ge, and a mixture thereof. The group IV compound may be a binary compound selected from the group consisting of SiC, SiGe, and a mixture thereof.

In this case, the binary compound, the ternary compound, or the quaternary compound may exist in the particles at a uniform concentration or may exist in the same particle after being divided into plural portions having different concentrations.

The quantum dot QD may have a core-shell structure including a core and a shell surrounding the core. In addition, the quantum dots QD may have a core/shell structure in which one quantum dot QD surrounds another quantum dot QD. An interface between the core and the shell may have a concentration gradient in which a concentration of elements existing in the shell is lowered as a distance from a center decreases.

The quantum dot QD may be a particle having a size of nanometer scale. The quantum dot QD may have a full width at half maximum (FWHM) of the light emitting wavelength spectrum, which is about 45 nm or less, preferably about 40 nm or less, more preferably about 30 nm or less, and a color purity or a color reproducibility may be improved in the above-mentioned range. In addition, since the light emitted through the quantum dot QD travels in all directions, an optical viewing angle may be improved.

In addition, the quantum dot QD is not limited to a specific shape. For example, the quantum dot QD may have a globular shape, a pyramid shape, a multi-arm shape, a cubic nano-particle, a nano-tube, a nano-wire, a nano-fabric, or a nanoplate-shaped particle.

According to an exemplary embodiment, the color conversion layer CCL may include the plural quantum dots QD that convert the light incident thereto to lights having colors of different wavelength ranges. Referring to FIG. 7, the color conversion layer CCL may include, for example, a first quantum dot QD1 that converts the incident light having a specific wavelength to light having a first wavelength and emits the light having the first wavelength and a second quantum dot QD2 that converts the incident light having the specific wavelength to light having a second wavelength and emits the light having the second wavelength. The first quantum dot QD1 may convert the first color light provided from the light emitting unit LU shown in FIG. 6 to the second color light, and the second quantum dot QD2 may convert the first color light provided from the light emitting unit LU to the third color light.

For example, when the light provided from the light emitting unit LU is light in the blue light wavelength range, the first quantum dot QD1 may convert the blue light to the light in the green light wavelength range, and the second quantum dot QD2 may convert the blue light to the light in the red light wavelength range. In detail, when the light provided from the light emitting unit LU is the blue light having a maximum light emission peak (or a center wavelength) in a wavelength range from about 420 nm to about 470 nm, the first quantum dot QD1 may emit the green light having a maximum light emission peak (or a center wavelength) in a wavelength range from about 520 nm to about 570 nm, and the second quantum dot QD2 may emit the red light having a maximum light emission peak (or a center wavelength) in a wavelength range from about 620 nm to about 670 nm. However, the blue light, the green light, and the red light are not limited to the above-mentioned wavelength ranges, and it should be understood that the wavelength ranges of the blue, green, and red lights include all wavelengths that may be recognized as the blue light, the green light, and the red light.

The color of the light emitted from the quantum dot QD may be changed depending on the particle size of the quantum dot QD, and the first quantum dot QD1 and the second quantum dot QD2 may have different particle sizes. For example, the particle size of the first quantum dot QD1 may be smaller than the particle size of the second quantum dot QD2. In this case, the first quantum dot QD1 may emit light having a relatively shorter wavelength than that of the second quantum dot QD2.

Barrier layers BL1 and BL2 may be disposed on the color conversion layer CCL. The barrier layers BL1 and BL2 may be disposed on an upper surface and a lower surface of the color conversion layer CCL. In an exemplary embodiment, at least one of the barrier layers BL1 and BL2 may be omitted. For example, the barrier layer may be disposed on only one surface of the upper surface and the lower surface of the color conversion layer CCL. For example, when an inorganic layer is disposed on the upper surface or the lower surface of the color conversion layer CCL, the barrier layer may be omitted.

In FIG. 6, the barrier layers BL1 and BL2 are disposed on the upper surface and the lower surface of the color conversion layer CCL, however, the barrier layers BL1 and BL2 may be disposed on a side surface of the color conversion layer CCL. For example, the barrier layers BL1 and BL2 may cover the color conversion layer CCL.

The barrier layers BL1 and BL2 may prevent moisture and/or oxygen (hereinafter, referred to as “moisture/oxygen”) from entering. The barrier layers BL1 and BL2 may include at least one inorganic layer. That is, the barrier layers BL1 and BL2 may include an inorganic material. For example, the barrier layers BL1 and BL2 may include silicon nitride, aluminum nitride, zirconium nitride, titanium nitride, hafnium nitride, tantalum nitride, silicon oxide, aluminum oxide, titanium oxide, tin oxide, cerium oxide, silicon oxynitride, or a metal thin film having a light transmittance. The barrier layers BL1 and BL2 may further include an organic layer. The barrier layers BL1 and BL2 may have a single-layered structure or a multi-layered structure.

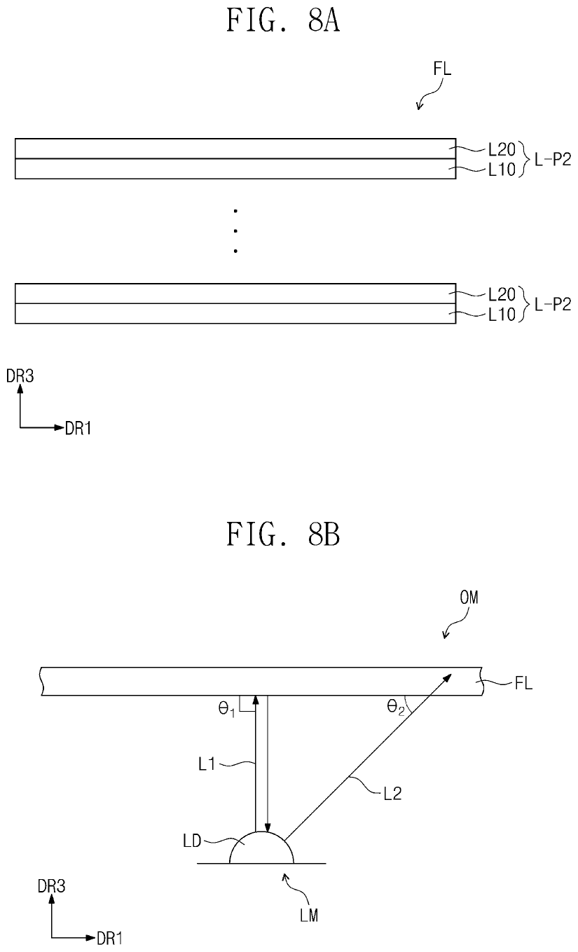

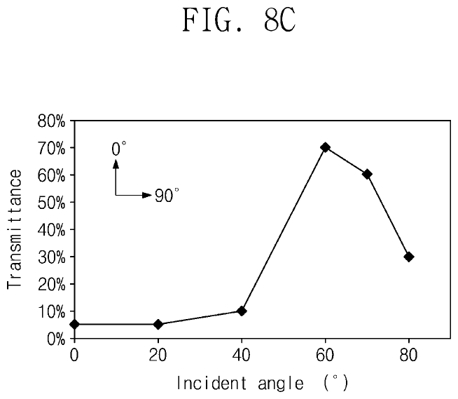

FIG. 8A is a cross-sectional view of an exemplary embodiment of a filter layer.

Referring to FIG. 8A, the filter layer FL may include a first refractive layer L10 and a second refractive layer L20, which have different refractive indices from each other. The filter layer FL may include at least one first refractive layer L10 and at least one second refractive layer L20. The first refractive layer L10 may have a refractive index from about 1.4 to about 1.6, and the second refractive layer L20 may have a refractive index from about 1.9 to about 2.1. The first refractive layer L10 and the second refractive layer L20 may be alternately stacked on each other. The filter layer FL may have a reflectance and a reflective wavelength, which are differently determined depending on a difference in refractive index between the first refractive layer L10 and the second refractive layer L20.

For example, the second refractive layer L20 having a relatively high refractive index may include a metal oxide material, and in detail, the second refractive layer L20 having the high refractive index may include at least one of TiOx, TaOx, HfOx, and ZrOx. In addition, the first refractive layer L10 having a relatively low refractive index may include SiOx or SiCOx. In addition, according to an exemplary embodiment, the filter layer FL may have a structure in which SiNx and SiOx are alternately and repeatedly deposited.

The first refractive layer L10 and the second refractive layer L20, which are successively stacked, may be defined as a unit layer L-P2. The filter layer FL may include a plurality of unit layers L-P2. For example, the filter layer FL may include three or more and fifteen or less unit layers L-P2, however, exemplary embodiments are not limited thereto or thereby. The configurations of the filter layer FL may be changed depending on a color quality implemented in the display device DD. The filter layer FL may have the reflectance and the reflective wavelength, which are differently determined depending on the number of the unit layers L-P2.

In addition, the first refractive layers L10 respectively included in the unit layers L-P2 may have different thicknesses from each other, and the second refractive layers L20 respectively included in the unit layers L-P2 may have different thicknesses from each other.

FIG. 8B is a diagram for illustrating optical characteristics of a filter layer.

Referring to FIG. 8B, the filter layer FL may reflect or transmit the light incident thereto from the light emitting element LD of the light source member LM depending on the incident angle of the light. In FIG. 8B, when the incident angle of light L1 is a reflection angle θ1, the filter layer FL may reflect the light L1, and when the incident angle of light L2 is a transmission angle θ2, the filter layer FL may transmit the light L2. For example, the reflection angle θ1 may correspond to 90 degrees, which is substantially vertical to the filter layer FL, and the transmission angle θ2 may correspond to an acute angle. The filter layer FL may reflect the light incident thereto at the reflection angle θ1, and thus, the hot-spot phenomenon occurring on the display panel DP disposed above the filter layer FL may be prevented or at least reduced. The transmission angle θ2 may correspond to the acute angle between about zero (0) degrees and about 90 degrees.

FIG. 8C is a graph illustrating transmittance of a filter layer for light having a specific wavelength according to the incident angle of the light.

Referring to FIG. 8C, the filter layer FL has a variable transmittance depending on the incident angle of light having a specific wavelength such as about 450 nm. For example, a center wavelength region of the light reflected by the filter layer FL may be changed depending on the incident angle of the light incident into the filter layer FL, and this may cause the transmittance of the filter layer FL for the light having the specific wavelength to vary depending on the incident angle. As the incident angle of the light incident into the filter layer FL increases, the center wavelength of the light reflected by the filter layer FL may be changed to a short wavelength. In FIG. 8C, when the incident angle of the light incident into the filter layer FL is about 10 degrees, most of the light is reflected in the wavelength range of about 450 nm. As the incident angle of the light incident into the filter layer FL gradually increases to about 40 degrees or about 60 degrees, the wavelength of the light reflected by the filter layer FL is shifted to a short wavelength region less than 450 nm, thereby increasing the light transmittance at the wavelength of about 450 nm. As the incident angle of the light incident into the filter layer FL gradually increases to about 40 degrees or about 60 degrees, the reflectivity of the light reflected by the filter layer FL may decrease compared with the case where the incident angle is about 10 degrees. In FIG. 8C, the transmittance of the light of the filter layer FL is maximum at the incident angle of about 60 degrees. The transmittance of the light in the filter layer FL gradually decreases at the incident angle greater than about 60 degrees. FIG. 8C merely shows an exemplary embodiment, and a maximum incident angle that is an incident angle at which the transmittance has a maximum value is not limited thereto or thereby. In an exemplary embodiment, the maximum incident angle may be included in a range from about 40 degrees to about 80 degrees.

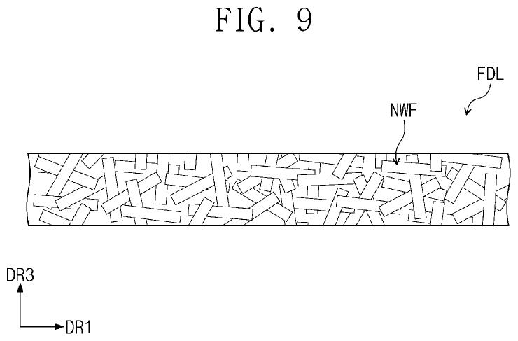

FIG. 9 is a cross-sectional view of an exemplary embodiment of a fiber diffusion layer.

In FIG. 9, the fiber diffusion layer FDL may be disposed on the base substrate BS. The fiber diffusion layer FDL may include a nonwoven fabric NWF of a random fiber structure. In this case, the nonwoven fabric NWF may correspond to a fiber assembly in which fibers are mechanically, chemically or thermally treated to form a fabric. The fiber diffusion layer FDL may be a flat porous sheet including the nonwoven fabric NWF. The fiber diffusion layer FDL may replace other diffusion plates and may be formed to have a thin thickness, to thereby reduce a size of the display device. According to an exemplary embodiment, the fiber diffusion layer FDL may be attached to an upper portion or a lower portion of the base substrate BS.

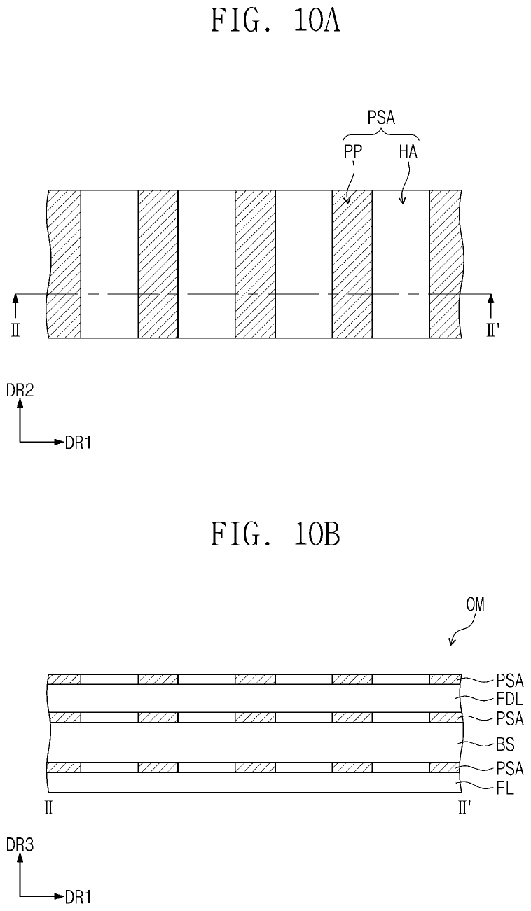

FIG. 10A is a plan view of an exemplary embodiment of an adhesive layer. FIG. 10B is a cross-sectional view taken along line II-II′ of FIG. 10A.

Referring to FIGS. 10A and 10B, one or more adhesive layers PSA may be coated between the optical functional layers of the optical member OM. The one or more adhesive layers PSA may attach the optical functional layers of the optical member OM to each other. The one or more adhesive layers PSA may be disposed between the base substrate BS and the filter layer FL, between the base substrate BS and the fiber diffusion layer FDL, and between the fiber diffusion layer FDL and the condensing layer PM. The adhesive layer PSA may be partially coated. For example, the adhesive layer PSA may include a plurality of patterns PP spaced apart from each other. For instance, the one or more adhesive layer PSA each may include a pattern PP having a shape defined by a plurality of openings HA. The adhesive layer PSA may be partially coated on each optical functional layer to improve a function of each optical functional layer without being entirely coated. Also, the partially coated adhesive layer PSA may prevent or reduce the function of each optical functional layer from being deteriorated by the adhesive. For example, the adhesive layer PSA may be partially coated on the condensing layer PM to improve a condensing function. The adhesive layer PSA may be partially coated on the fiber diffusion layer FDL to prevent or reduce an adhesive from entering the nonwoven fabric NWF and to improve a diffusion function of the fiber diffusion layer FDL.

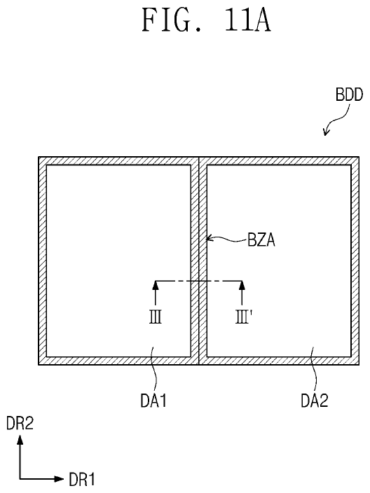

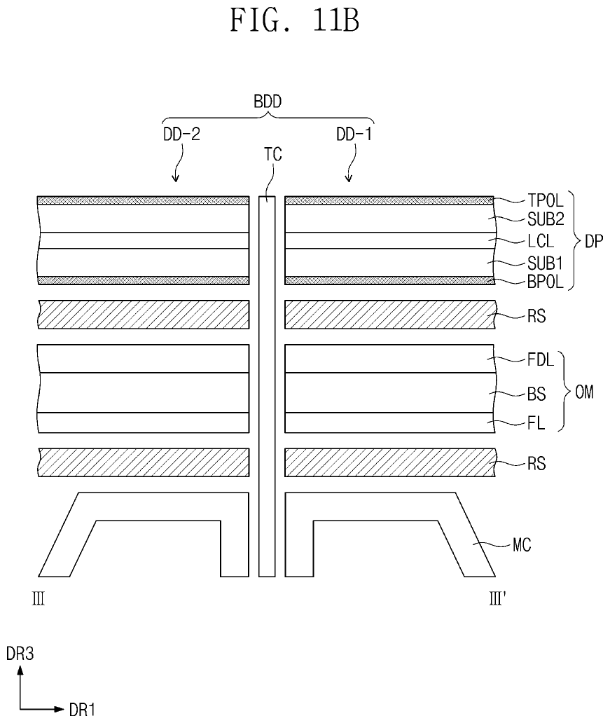

FIG. 11A is a plan view of a tiled display device constructed according to the principles of the invention. FIG. 11B is a cross-sectional view taken along line III-III′ of FIG. 11A according to an exemplary embodiment.

Referring to FIGS. 11A and 11B, the tiled display device BDD may include a first display area DA1, a second display area DA2, and a bezel area BZA. The first display area DA1 and the second display area DA2 may be disposed adjacent to each other and may include a first display device DD-1 and a second display device DD-2, respectively. The bezel area BZA may be disposed between the first display area DA1 and the second display area DA2. The bezel area BZA may correspond to a boundary between the first display area DA1 and the second display area DA2. The tiled display device BDD including a plurality of display devices such as the first and second display devices DD-1 and DD-2 may be employed in a public information display (PID).

In FIG. 11B, the tiled display device BDD may include the first display device DD-1 and the second display device DD-2. The first display device DD-1 may be disposed in the first display area DA1, and the second display device DD-2 may be disposed in the second display area DA2. The first display device DD-1 and the second display device DD-2 may be spaced apart from each other by a predetermined distance with a top chassis TC interposed therebetween. The top chassis TC may include a first top chassis of the first display device DD-1 and a second top chassis of the second display device DD-2. The top chassis TC may be disposed in the bezel area BZA. Each of the first and second display devices DD-1 and DD-2 may include a display panel DP, an optical member OM, a light source member disposed under the optical member OM, and a middle chassis MC. The first and second display devices DD-1 and DD-2 may have substantially the same structure and configurations as those described above with reference to the display device DD of FIGS. 1 to 10B, and redundant descriptions thereof will be omitted. Each of the first and second display devices DD-1 and DD-2 may include one or more mold members RS. One of the mold members RS may support the display panel DP to allow the display panel DP to be spaced apart from the optical member OM by a predetermined distance. Another one of the mold members RS may support the optical member OM to allow the optical member OM to be spaced apart from the middle chassis MC by a predetermined distance.

The optical member OM of each of the first display device DD-1 and the second display device DD-2 may include a filter layer FL having a reflectance and a transmittance, which vary depending on the incident angle of light at a specific wavelength, a fiber diffusion layer FDL disposed on the filter layer FL and including a nonwoven fabric NWF, and a base substrate BS disposed on the filter layer FL and having a thermal expansion coefficient lower than thermal expansion coefficients of the fiber diffusion layer FDL and the filter layer FL. The base substrate BS may be disposed between the fiber diffusion layer FDL and the filter layer FL and may perform a heat dissipation function to dissipate heat generated from the fiber diffusion layer FDL and the filter layer FL. Also, the base substrate BS may suppress expansion of the fiber diffusion layer FDL and the filter layer FL caused by the heat since the fiber diffusion layer FDL and the filter layer FL are attached to the base substrate BS and the base substrate BS has the thermal expansion coefficient lower than those of the fiber diffusion layer FDL and the filter layer FL. Accordingly, the tiled display device BDD may be provided and/or designed such that the distance between the first display device DD-1 and the second display device DD-2 decreases, and thus, the size of the bezel area BZA may be reduced.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A display device comprising:
a first member comprising a light emitting unit to emit light;
a second member disposed on the first member; and
a display panel disposed on the second member, the second member comprising:
a base substrate;
a fiber diffusion layer disposed on the base substrate and comprising a nonwoven fabric; and
a filter layer disposed under the base substrate and facing the first member, the filter layer having a reflectance and a transmittance, which vary depending on an incident angle of light of a specific wavelength, wherein the base substrate has a thermal expansion coefficient lower than thermal expansion coefficients of the fiber diffusion layer and the filter layer.

2. The display device of claim 1, wherein the display panel comprises a color conversion layer comprising quantum dots to convert the light from a first color to a second color and a third color.

3. The display device of claim 1, wherein the filter layer comprises a plurality of first refractive layers and a plurality of second refractive layers alternately disposed with the first refractive layers, and the first refractive layers have a refractive index different from a refractive index of the second refractive layers.

4. The display device of claim 1, wherein the filter layer is configured to selectively reflect light of a specific wavelength band.

5. The display device of claim 4, wherein the specific wavelength band of light is about 450 nm.

6. The display device of claim 5, wherein the transmittance has a maximum value in response to the incident angle being in a range from about 40 degrees to about 80 degrees.

7. The display device of claim 1, wherein the filter layer is disposed directly under the base substrate.

8. The display device of claim 1, wherein the fiber diffusion layer is disposed above the base substrate and faces the display panel.

9. The display device of claim 1, wherein the fiber diffusion layer is disposed between the base substrate and the filter layer.

10. The display device of claim 1, wherein the second member comprises an optical member including the base substrate, the fiber diffusion layer, and the filter layer, and the optical member further comprises a light diffusion layer that is disposed on the fiber diffusion layer to convert light corresponding to a linear light source or a point light source to light corresponding to a surface light source.

11. The display device of claim 1, wherein the second member further comprises an adhesive layer disposed at least one of between the base substrate and the filter layer and between the base substrate and the fiber diffusion layer.

12. The display device of claim 11, wherein the adhesive layer comprises a plurality of patterns spaced apart from each other.

13. The display device of claim 11, wherein the adhesive layer comprises a plurality of openings.

14. The display device of claim 1, wherein the second member further comprises a dual brightness enhancement film (DBEF) disposed on the base substrate.

15. The display device of claim 1, wherein the first member comprises a light source member including the light emitting unit, the light emitting unit comprising:
a circuit board; and
a plurality of light emitting elements disposed on the circuit board and independently activated.

16. The display device of claim 1, wherein the second member further comprises a condensing layer disposed on the fiber diffusion layer, and the fiber diffusion layer is disposed between the condensing layer and the base substrate.

17. The display device of claim 1, wherein the second member further comprises:
a condensing layer disposed on the base substrate; and
a dual brightness enhancement film (DBEF) disposed on the condensing layer.

18. A display device comprising:
a first member comprising a light emitting unit to emit light;
a second member disposed on the first member; and
a display panel disposed on the second member, the second member comprising:
a base substrate;
a fiber diffusion layer disposed on the base substrate and comprising a nonwoven fabric;
a filter layer disposed under the base substrate and facing the first member, the filter layer having a reflectance and a transmittance, which vary depending on an incident angle of light of a specific wavelength; and
a color conversion layer disposed on the base substrate and comprising quantum dots to convert the light from a first color to a second color and a third color,
wherein the base substrate has a thermal expansion coefficient lower than thermal expansion coefficients of the fiber diffusion layer and the filter layer.

19. The display device of claim 18, wherein the second member comprises an optical member including the base substrate, the fiber diffusion layer, and the filter layer, and the optical member further comprises a barrier layer disposed on at least one of an upper surface and a lower surface of the color conversion layer.

20. A tiled display device comprising:
a first display area and a second display area, which are adjacent to each other in a plan view and respectively comprise display devices; and
a bezel area disposed between the first display area and the second display area, each of the display devices comprising:
a first member comprising a light emitting unit to emit light;
a second member disposed on the first member; and
a display panel disposed on the second member, the second member comprising:
a base substrate;
a fiber diffusion layer disposed on the base substrate and comprising a nonwoven fabric; and
a filter layer disposed under the base substrate and facing the first member, the filter layer having a reflectance and a transmittance, which vary depending on an incident angle of light of a specific wavelength, wherein the base substrate has a thermal expansion coefficient lower than thermal expansion coefficients of the fiber diffusion layer and the filter layer.
